(19) United States
(12) Patent Application Publication
(10) Pub. No.: US 2025/0083076 A1
(43) Pub. Date: Mar. 13, 2025

(54) BAG FILTER HOUSING LARGE-BORE VALVE DUPLEX FILTER WITH HYDRAULIC LIFT ASSIST

(71) Applicant: EXACTRATION, LLC, Shepherdsville, KY (US)

(72) Inventor: Brent D. Terrell, Bardstown, KY (US)

(21) Appl. No.: 18/809,293

(22) Filed: Aug. 19, 2024

Related U.S. Application Data
(60) Provisional application No. 63/533,268, filed on Aug. 17, 2023.

(51) Int. Cl. B01D 35/12; B01D 29/11

(52) U.S. Cl. CPC B01D 35/12; B01D 29/114

(57) ABSTRACT

A bag filter housing large bore valve duplex for HVAC systems uses hydraulic lift assist to arrange two large diameter bag filters or suction strainers in parallel with common inlet/outlet piping connections and four large bore butterfly valves and integrates the four valve gear operators such that a user can open two valves while closing the other two valves simultaneously using a single gear operator. A hydraulic lift assist feature enables the user to easily lift the heavy filter housing cover with little effort.

### TECHNICAL FIELD

The present invention relates to valve means for switching between duplex filter units.

### BACKGROUND OF THE INVENTION

This invention relates to duplex filter plants comprising a pair of filter units arranged so that the flow of fluid, in this particular application, air, to be filtered can be changed over from one unit to another unit so that when one unit is brought into service, the other can be withdrawn for servicing so that the unit not in service can be cleaned by a reflux flow of filtered fluid to remove foreign matter which may result in clogging of the filter element. The configuration provides a means for separation of a clogged or used filter element from a fluid system without prolonged interruption in the continuity of the fluid flow.

The idle filter elements is then available for cleaning or replacement while the other filter element is in operation. When the operating filter element becomes substantially clogged or due for replacement the previously cleaned filter element is positioned in the fluid line while the operating filter element is removed for cleaning or replacement. This enables the fluid flow to continue uninterrupted.

Duplex filter devices have an inlet chamber, and outlet chamber, a pair of filtering compartments, connecting passageways and suitable valve means and actuating mechanisms for fluid circulation from the inlet to the outlet through either of the filter elements. The compartments are separated by a common partition which include switching valve members adapted to selectively connect the outlet and inlet chambers to one of the filter elements while simultaneously disconnecting the other filter element from the inlet and outlet chambers of the device. The valves are connected to each other and movable together as an integral unit to prevent opening or closing of any port relative to another port which is open.

When using lines of considerable size handling a high volume of fluid, the weight of the covers of the compartments containing the filter elements make it extremely difficult to shift the valve members in order to divert the fluid flow from one chamber to the other chamber. Thus, there is a need to provide a duplex filtering device whereby the pressure between the two filter element chambers can be balanced when switching from one chamber to the other especially for portable standalone units for HVAC units.

### SUMMARY

It's important to maintain a constant flow of volume in HVAC systems, so typically valves are opened and closed simultaneously or as close as possible to maintain a steady state stream of air. Closing small hand valves is simple but a problem occurs with large industrial valves which require reducing gears to close the valves.

The present invention provides means for arranging two large diameter bag filters or suction strainers in parallel with common inlet/outlet piping connections and four large bore butterfly valves and integrating the four valve gear operators such that a user can open two valves while closing the other two valves simultaneously using one gear operator. The hydraulic lift assist feature enables the user to easily lift the heavy filter housing cover with little effort.

The bag filter housing large-bore valve duplex feature involves arranging two large diameter bag filters or suction strainers in parallel with common inlet/outlet piping connections and four large bore butterfly valves with gear operators, and coupling the four gear operators such that a user can open two valves while closing the other two valves simultaneously using one gear operator. The hydraulic lift assist feature enables the user to easily lift the heavy filter housing cover for media access with minimal effort.

The cooling tower filtration industry cannot easily switch from one operating duplex bag filter housing to a alternate filter housing from one common location operating all four isolation valves simultaneously. Typically, these valves are large bore exceeding 12″ pipe size. The user must physically rotate the gear operator on each of the four valves to accomplish the same valve position creating longer periods of downtime. The possibility of the user not fully opening or closing a valve resulting in faulty operation, failure or risk of injury.

With the instant design, a user simply rotates the handwheel on one valve gear operator to open/close all of the coupled valves.

In the instant invention, each filter housing shell has two large bore valves (most likely butterfly type) that are both positioned either open or close. When two housings are coupled together, the valves must be in opposite positions to allow one housing to be in operation while the other in standby mode. Thus, the valves attached to the housing in operation must both be open while the valves on the standby housing must be closed. These housings are normally in operation with fluid. To change the operating housing to standby mode and the standby housing to operation mode, a user physically rotates the gear operator on one selected valve which changes the valve position of the other three valves simultaneously. Without this feature, the user would have to physically rotate the gear operator on each of the four valves to accomplish the same valve position. This creates downtime and an the possibility of the user not fully opening or closing a valve resulting in faulty operation or risk of injury.

Further, the hydraulic lift assist feature for the filter housings allows the user to easily lift and swing the housing cover allowing full access to the filter housing media screens (or filter elements) inside the filter housing.

It is an objective of the present invention to provide a duplex filter system having a large filtration service with a switch over without pressure shock.

It is an objective of the present invention to provide hydraulic lift assist for easy maintenance.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is an elevated view of a duplex filtering device;

FIG. 2 is a plan top view of the duplex filtering device of FIG. 1;

FIG. 3 is a front elevation view of the duplex filtering device of FIG. 1 showing the stand-by housing top head assembly in the raised position supported by the hydraulic jack;

FIG. 4 is an isometric view of the duplex filtering device;

FIG. 5 is an isometric view showing a filter housing shell, top head assembly, and the hydraulic jack assembly for lifting the cover;

FIG. 6 is a perspective view showing the duplex filtering device the gear assembly and top head assembly lifted and separated from the filter housing shell using the hydraulic jack; and

FIG. 7 is a perspective view of the duplex filtering device showing the valve handwheel valve shafts coupled together, coupler sprockets and valve gear operator.

### DESCRIPTION OF THE PREFERRED EMBODIMENTS

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “about” can be reasonably appreciated by a person skilled in the art to denote somewhat above or somewhat below the stated numerical value, to within a range of ±10%.

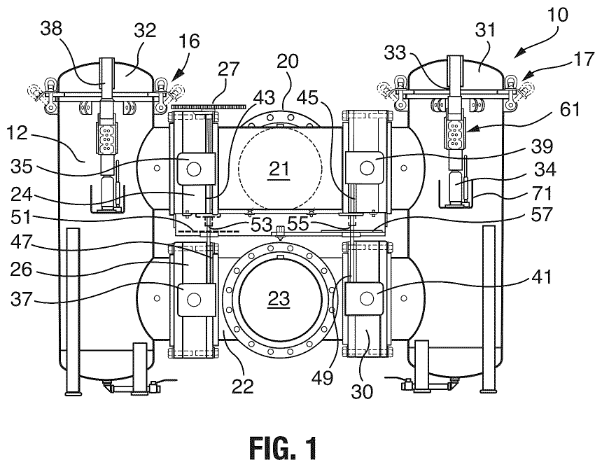

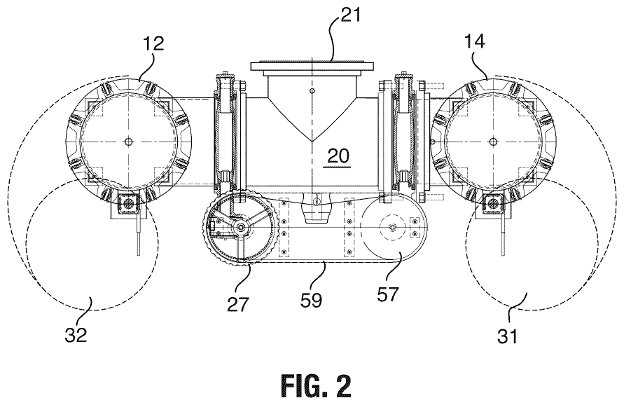

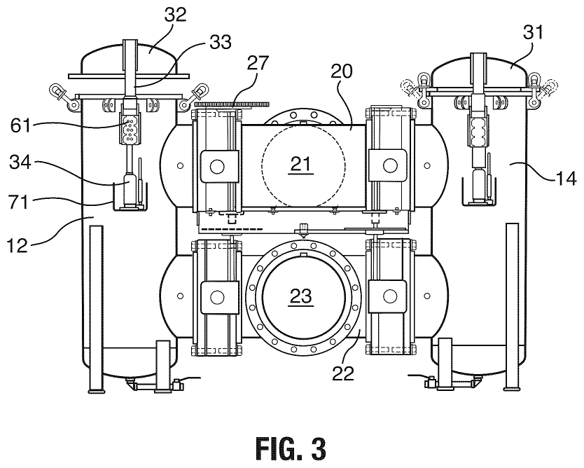

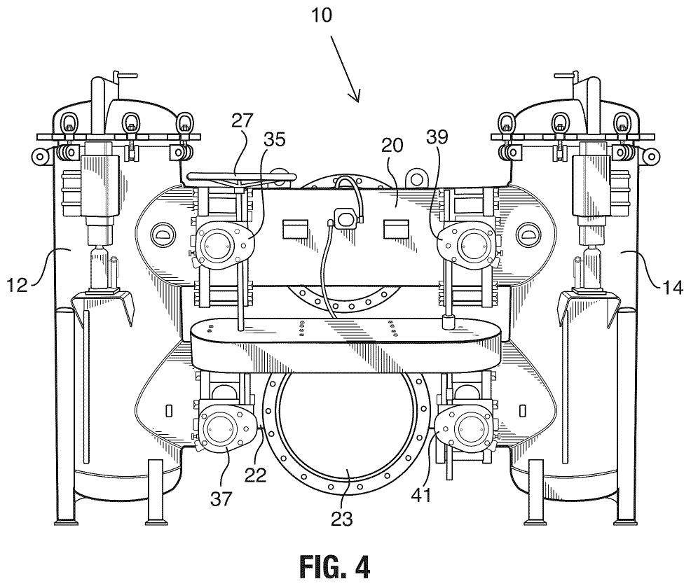

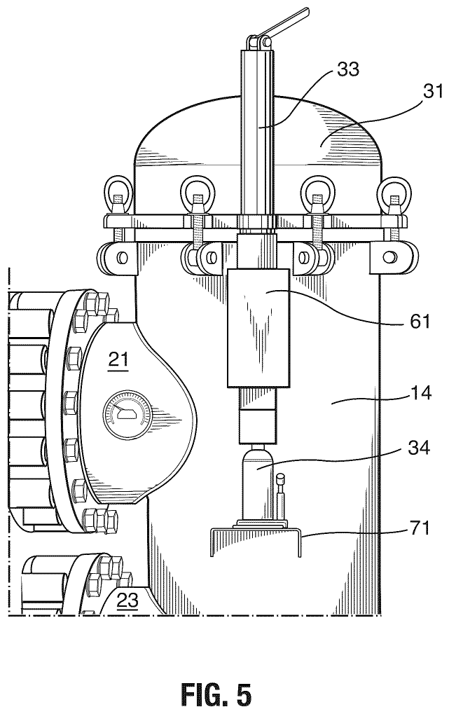

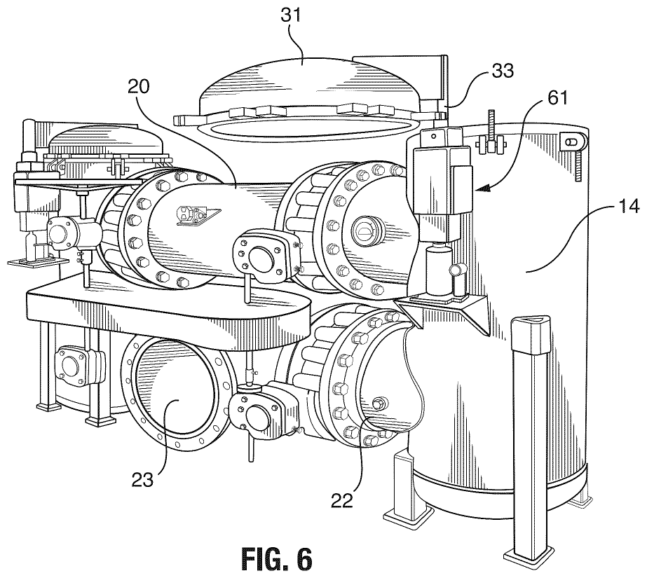

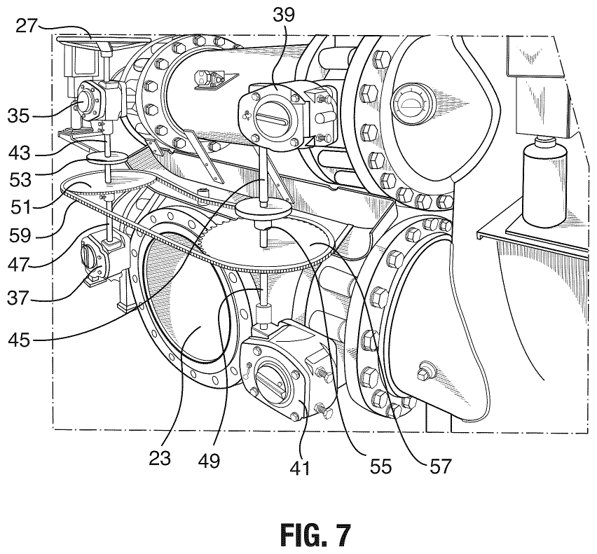

As shown in FIGS. 1-7, the duplex filter device 10 comprises a pair of vertical cylindrical filter housings, A first filter housing 12 and a second filter housing 14, each one holding a removable filter element (not shown) therein. The filter elements are adapted to provide a fluid tight seal against the interior wall of the housing so that fluid must flow through the filter elements. A top horizontal conduit 20 and bottom horizontal conduit 22 are connected to the top and bottom of the housings providing fluid flow therebetween. Fluid enters the top horizontal conduit 20 through inlet 21 and exits the bottom horizontal conduit through fluid outlet 23. A first valve 24 and second valve 26 are inserted at each end of the top horizontal conduit and a third valve and a fourth valve are inserted in the bottom horizontal conduit to control the flow of fluid entering and exiting the housings.

A first top head assembly 16 of the first filter housing includes a removable first cap or first cover 31 which can be detached (unbolted) from the filter housing, lifted upward by a first shaft 33 extending from a first hydraulic jack 34 and pivoted on a shaft providing clearance for removal of the filter elements for inspection or replacement when necessary. A second top head assembly 17 of the second filter housing includes a removable second cap or second cover 32 which can be detached (unbolted) from the filter housing, lifted upward by a second shaft 38 extending from a first hydraulic jack 34 and pivoted on the shaft providing clearance for removal of the filter elements for inspection or replacement when necessary.

In one preferred portable stand alone embodiment, the duplex filter device 10 includes a pair of filter housings, first filter housing 12 and second filter housing 14, each one of the filter housing (sometimes referred to as filter housing shells) have two large bore valves, such as butterfly valves, that are both positioned either open or close. When both housings are coupled together, the valves must be in opposite positions to allow one housing to be in operation while the other in standby mode. The valves attached to the housing in operation must both be open while the valves on the standby housing must both be closed. These housings are normally in operation with water or diluted coolant solutions.

A manually rotatable changeover device for rotating each of the valves into predetermined positions is accomplished by butterfly valve means mounted on shafts which are connected to gear operators in mesh with a control gear provided with a manual operated handwheel or lever. The four large bore butterfly valve gear operators are coupled together for simultaneously opening/closing of the valves by manually turning one valve operator handwheel 27. This is accomplished by coupling the gear operators: (first gear operator 35, second gear operator 37, third gear operator 39 and fourth gear operator 41), and respective valve shafts: (first shaft 43, second shaft 45, third shaft 47, and fourth shaft 49 on the adjacent valves (top & bottom) at each housing. A large diameter first sprocket 51 is installed in the horizontal plane on the coupled shaft 53 (between joined first top shaft 36 and first bottom shaft 37) and a large diameter second sprocket 57 is installed in the horizontal plane on the coupled shaft 55 (between joined second top shaft 39 and second bottom shaft 41). The first sprocket and second sprocket are coupled together with a belt or roller chain 59. The valves are rotated into a predetermined position such that one of the units is connected in service to filter fluid and the other unit is withdrawn from service and isolated from the conduits.

To change the operating housing to standby mode and the standby housing to operation mode. A gear operator assembly connects and cooperatively engages each one of the independent gear operators of each valve so that a user physically rotating the gear operator on a selected valve engages the other three valves changing the valve position of the other three valves simultaneously.

The hydraulic lift device is mounted on a jack support bracket 71 affixed to the exterior wall of the filter housing and is connected to a lifting mechanism 61 including a hydraulic piston assembly having a vertical shaft extending therefrom into a receiver mounted on a selected side of the top head assembly in alignment with the vertical shaft. Upon decoupling cover from the top head assembly of the housing, it is lifted upward a distance to clear the housing and allow pivoting of the top head assembly out of alignment with the housing providing sufficient clearance to remove a filter element from the housing. The simply lifts and swings the top head assembly to the side allowing full access to the filter housing media screens (or filter elements) inside the filter housing. The cover has the capability of 360° swing with a simple hand push. The hydraulic jack and lifting mechanism varies in size and lifting capacity based upon the weight of the head to be lifted.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. A duplex filter device, comprising:
a pair of vertical filter housings defining a first filter housing and a second filter housing;
a top horizontal conduit connecting a top portion of said first filter housing and said second filter housing and a bottom horizontal conduit connecting a bottom portion of said first filter housing and said second filter housing;
said top horizontal conduit including an medial inlet for fluid flow and said bottom horizontal conduit including an medial outlet for fluid flow;
said top horizontal conduit including a first valve disposed between said first filter housing and said medial inlet and a second valve disposed between said second filter housing and said medial inlet, and a third valve disposed between said first filter housing
said bottom horizontal conduit including a third valve disposed between said first filter housing and said medial inlet and a fourth valve disposed between said second filter housing and said medial inlet;
a first top head assembly attaching to said first filter housing including a removable first cover providing a fluid tight seal therewith and including a rotatable vertical shaft supporting said first cover in a raised position providing clearance for removal of a filter element from said first filter housing for inspection or replacement;
a second top head assembly attaching to said second filter housing including a removable second cover providing a fluid tight seal therewith and including a rotatable vertical shaft supporting said second cover in a raised position providing clearance for removal of a filter element from said second filter housing for inspection or replacement;
a first hydraulic jack supported by a first bracket on said first filter housing, said first hydraulic jack including a first hydraulic piston in cooperative engagement with said rotatable vertical shaft for lifting said first cover in a raised position;
a second hydraulic jack supported by a second bracket on said second filter housing, said second hydraulic jack including a second hydraulic piston in cooperative engagement with said rotatable vertical shaft for lifting said second cover in a raised position;
a manually rotatable changeover device including a plurality of gear operators for rotating said first valve, said second valve, said third valve, and said fourth valve into predetermined positions comprises a first gear operator coupled to a first shaft in cooperative engagement with said first valve, a second gear operator coupled to a second shaft in cooperative engagement with said second valve, a third gear operator coupled to a third shaft in cooperative engagement with said third valve, and a fourth gear operator coupled to a fourth shaft in cooperative engagement with said fourth valve, said first shaft and said third shaft are coupled together in vertical alignment and said second shaft and said fourth shaft are coupled together in vertical alignment;
a first sprocket supported by and cooperatively engaging said first shaft and said third shaft, and a second sprocket supported by and cooperatively engaging said second shaft and said fourth shaft are coupled together by a roller chain; and
means for rotating said first sprocket extends from a top distal end of said first shaft or said second shaft and said first gear operator, said second gear operator, said third gear operator and said fourth gear operator are coupled together for simultaneously opening/closing of said first valve, said second valve, said third valve, and said fourth valve to a predetermined position by manually turning one valve operator handwheel.

2. The duplex filter device of claim 1, wherein said means for rotating said first sprocket and said second sprocket is a handwheel.

3. The duplex filter device of claim 1, wherein said valve comprises a butterfly valve.
